(19) United States
(12) Patent Application Publication
(10) Pub. No.: US 2019/0392395 A1
(43) Pub. Date: Dec. 26, 2019

(54) WORRY-FREE MEETING CONFERENCING

(71) Applicant: Microsoft Technology Licensing, LLC, Redmond, WA (US)

(72) Inventor: Jamil Amirali Valliani, Kirkland, WA (US)

(21) Appl. No.: 16/014,522

(22) Filed: Jun. 21, 2018

(51) Int. Cl. G06Q 10/10; G10L 15/02; H04L 12/58; H04L 29/06; G10L 15/06

(52) U.S. Cl. CPC G06Q 10/109; G10L 15/02; H04L 51/02; G06F 15/18; H04L 51/046; G10L 15/06; H04L 65/403

(57) ABSTRACT

Described herein are processing operations enabling an exemplary virtual assistant to understand context for a meeting invite and execute new functionality such as automatically calling a user to connect to a meeting when the meeting begins. A virtual assistant is programmed with skills for meeting management that adapts operation of the virtual assistant to enable users to utilize the virtual assistant with meeting scheduling and meeting execution. Exemplary skills for meeting management provide a layer of intelligence over raw application data where a virtual assistant extracts electronic meeting details from an electronic meeting invite and utilizes the extracted meeting details to execute tasks for user assistance. Exemplary tasks comprise but are not limited to: automatically calling a user computing device when a meeting starts; meeting attendee detection (including status of meeting attendees; service-based messaging capabilities; and extension of virtual assistant functionality during a live conferencing session, among other examples.

### BACKGROUND

Users commonly face situations where they have to recall meeting details to connect to a scheduled meeting. In some cases, the meeting details may not be readily accessible to a user, which can delay connection to a meeting if a user is unable to locate meeting details. Additionally, users typically have to manually dial-in to a conferencing call and enter other meeting-specific details such as a conferencing ID number and provide attendee identification. This is a tedious task for users and results in additional latency when connecting to a meeting. Such tasks become especially cumbersome when a user does not have the meeting details readily available for connecting to a meeting. Thus, processing operations related to meeting connection and task execution can be improved, for example, through automating processing for connecting a user to a meeting.

Moreover, additional technical challenges result when trying to connect a meeting. Typically, users have to access data from different applications/services to connect to a meeting which is presented in a different application/service, over the phone, etc. This requires additional bandwidth and resources of a computing device to be tied up just to access a meeting. Furthermore, cross-application/service interfacing is limited between applications/services for processing related to management of a meeting. This also limits processing efficiency when a user attempts to join a meeting or execute tasks before, during or after a meeting. For instance, users tend to rely on virtual assistant application/services for task execution. A virtual assistant is a software agent that can perform tasks or services on behalf of a user. However, traditional virtual assistant application/services provide limited functionality with respect to processing operations for meeting management, which do not entail processing that enable automated calling of a user computing device to initiate a meeting nor assistance within an active conferencing session, among other technical advantages.

### SUMMARY

In view of the foregoing technical challenges, the present disclosure relates to processing operations that enable an exemplary virtual assistant to understand context for a meeting invite and execute new functionality, on behalf of a user, such as automatically calling a user to connect the user to a meeting when the meeting begins. This eliminates the need for a user to have to manually attempt to connect to a meeting. A virtual assistant is programmed with skills for meeting management that adapts operation of the virtual assistant to enable users to utilize the virtual assistant with meeting scheduling and meeting execution. Exemplary skills for meeting management provide a layer of intelligence over raw application data where a virtual assistant extracts electronic meeting details from an electronic meeting invite and utilizes the extracted meeting details to execute tasks for user assistance. Non-limiting examples of tasks comprise but are not limited to: automatically calling a user computing device when a meeting starts; meeting attendee detection (including status of meeting attendees in a conferencing session); and extension of virtual assistant functionality during a live conferencing session, among other examples.

In one example, a virtual assistant is added as a participant in a conferencing session (e.g., public switched telephone network, IP telephony/videotelephony) where a user can interface with the virtual assistant directly in a meeting forum. Such interactions may directly result in controlling parameters of a conferencing session. In other examples, a user may interface with a user interface of the virtual assistant, through a user computing device, to provide updates or commands for controlling parameters of a conferencing session. Examples described herein extend to those in which a virtual assistant application/service is natively installed on a computing device (e.g., user computing device) as well as service examples that do not require interactions directly through a user interface of a virtual assistant. For instance, a user may register a phone number or email address with a virtual assistant service and received notifications and updates through text message (e.g., SMS message) or email, among other modalities.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an exemplary process flow providing exemplary components for meeting management through an exemplary virtual assistant, with which aspects of the present disclosure may be practiced.

FIG. 2 illustrates an exemplary method related to meeting management through an exemplary virtual assistant, with which aspects of the present disclosure may be practiced.

FIGS. 3A-3I illustrate exemplary processing device views providing exemplary interactions of a virtual assistant service, with which aspects of the present disclosure may be practiced.

FIG. 4 illustrates a computing system suitable for implementing processing of an exemplary virtual assistant as well as other applications/services of a platform, with which aspects of the present disclosure may be practiced.

### DETAILED DESCRIPTION

Non-limiting examples of the present disclosure relates to processing operations that enable an exemplary virtual assistant to understand context for a meeting invite and execute new functionality, on behalf of a user, such as automatically calling a user to connect the user to a meeting when the meeting begins. This eliminates the need for a user to have to manually attempt to connect to a meeting. A virtual assistant is programmed with skills for meeting management that adapts operation of the virtual assistant to enable users to utilize the virtual assistant with meeting scheduling and meeting execution. Exemplary skills for meeting management provide a layer of intelligence over raw application data where a virtual assistant extracts electronic meeting details from an electronic meeting invite and utilizes the extracted meeting details to execute tasks for user assistance. Non-limiting examples of tasks comprise but are not limited to: automatically calling a user computing device when a meeting starts; meeting attendee detection (including status of meeting attendees in a conferencing session); and extension of virtual assistant functionality during a live conferencing session, among other examples. In one example, a virtual assistant is added as a participant in a conferencing session (e.g., public switched telephone network, IP telephony/videotelephony) where a user can interface with the virtual assistant directly in a meeting forum. Such interactions may directly result in controlling parameters of a conferencing session. In other examples, a user may interface with a user interface of the virtual assistant, through a user computing device, to provide updates or commands for controlling parameters of a conferencing session.

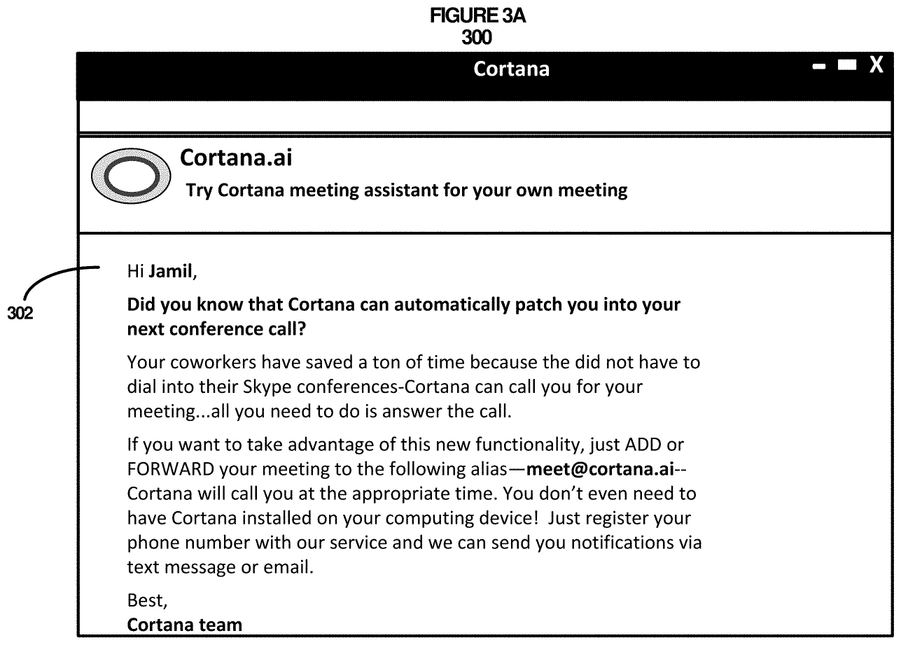

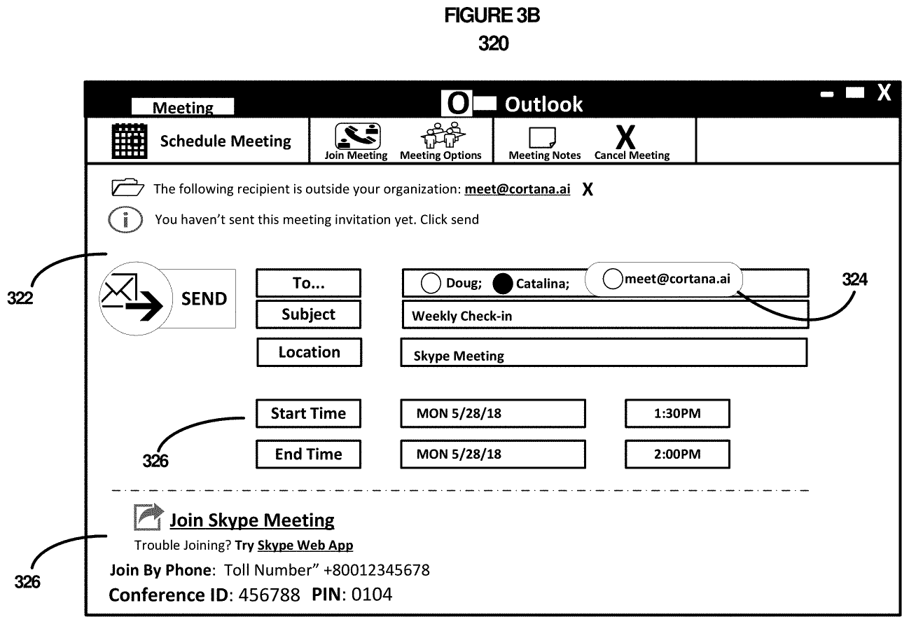

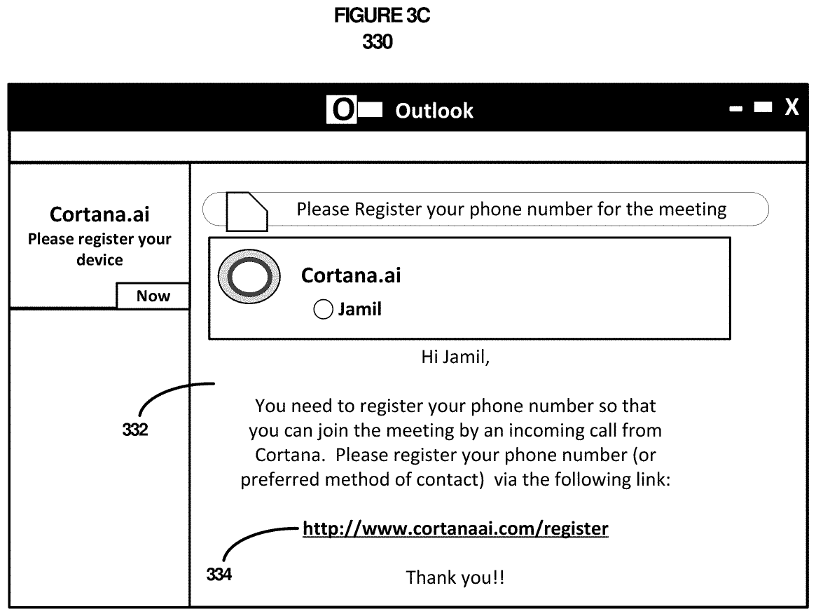

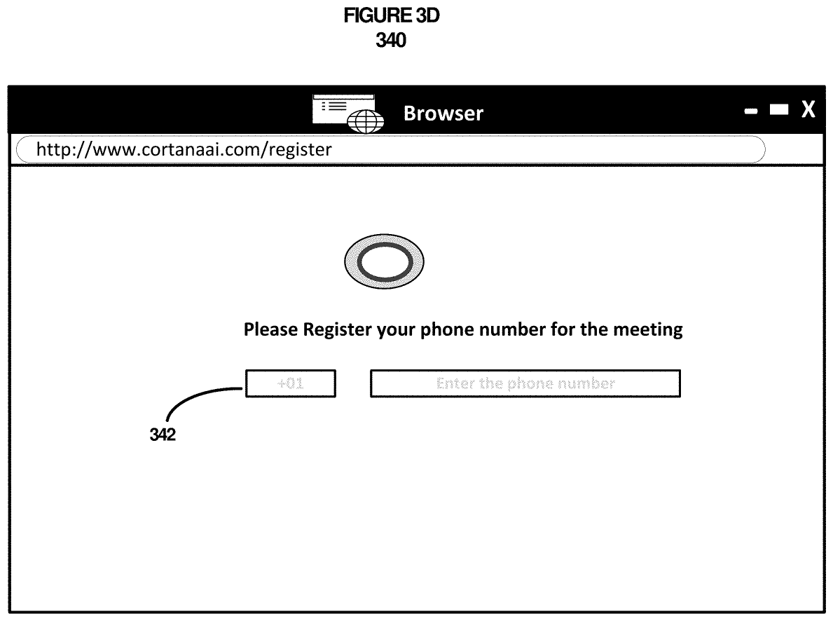

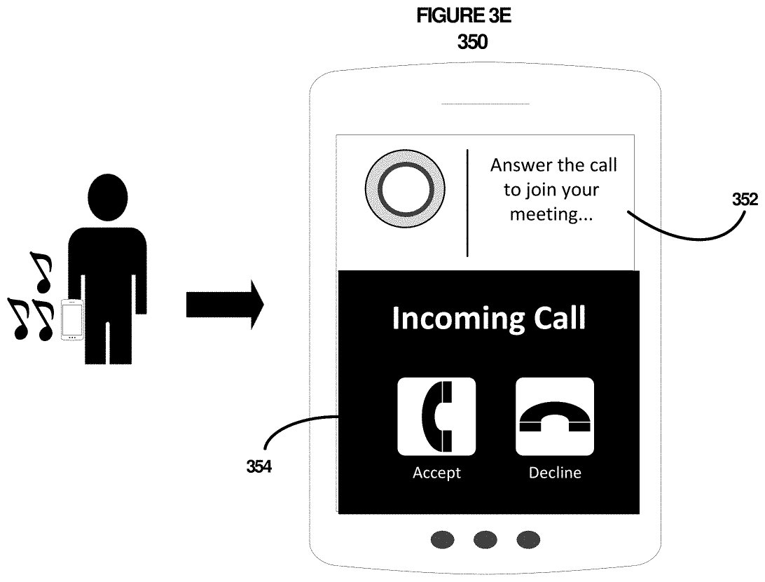

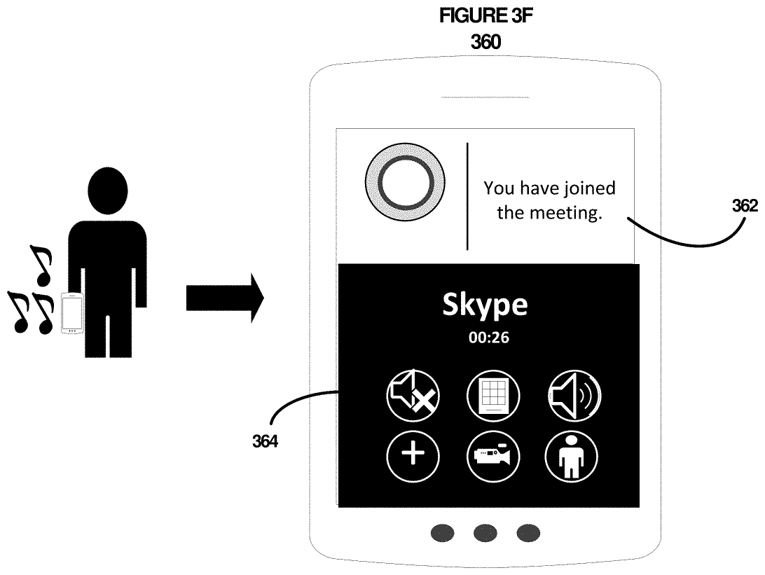

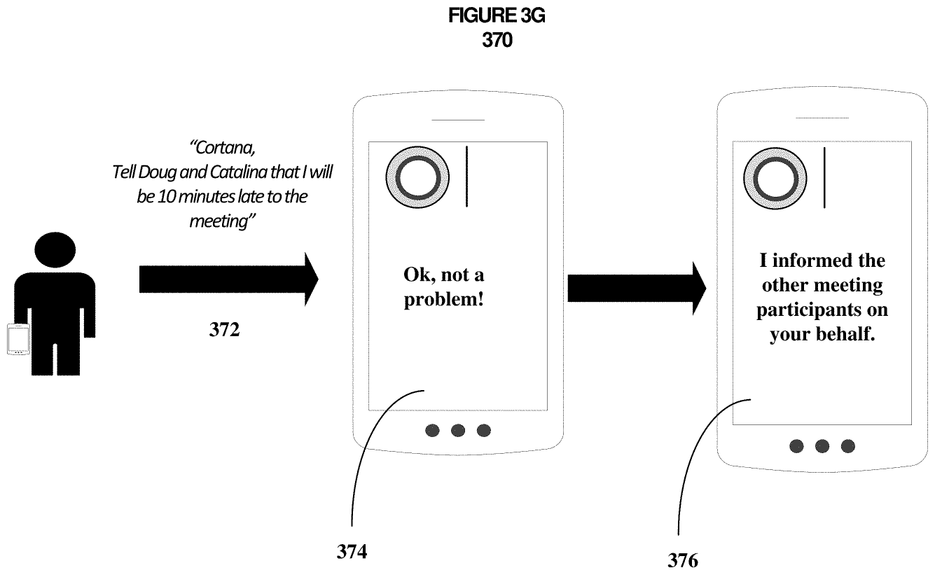

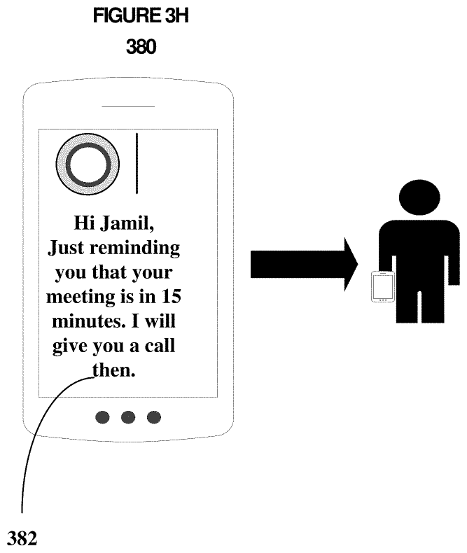

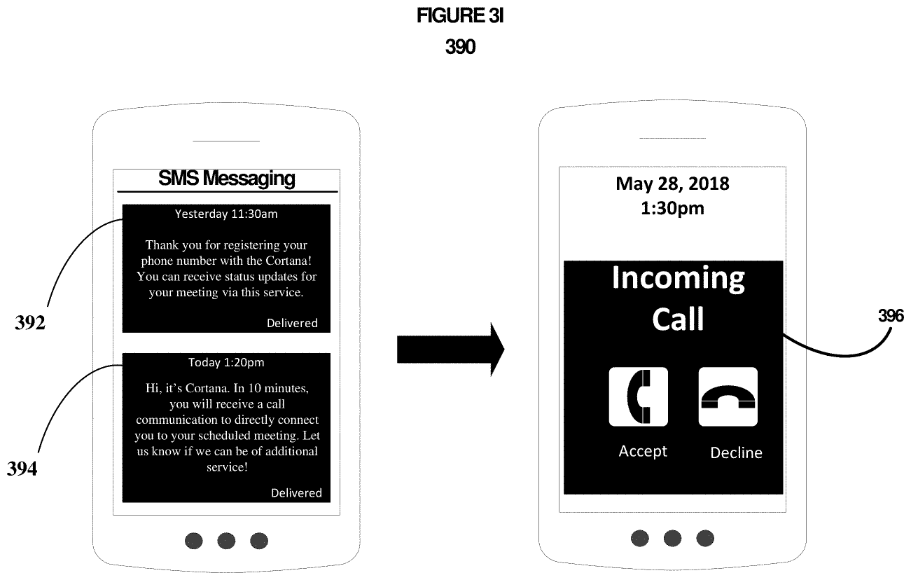

Examples described herein extend to those in which a virtual assistant application/service is natively installed on a computing device (e.g., user computing device) as well as service examples that do not require interactions directly through a user interface of a virtual assistant. For instance, a user may register a phone number or email address with a virtual assistant service and received notifications and updates through text message (e.g., SMS message) or email, among other modalities. A non-limiting service example (e.g., virtual assistant service) that does not require messaging to occur through a user interface of a virtual assistant is illustrated in FIG. 3I.

A virtual assistant is a software agent that can perform tasks or services on behalf of a user. Virtual assistant services operate to keep users informed and productive, helping them get things done across devices and platforms. Commonly, virtual assistant services operate on mobile computing devices such as smartphones, laptops/tablets and smart electronic devices (e.g., speakers). Real-world examples of virtual assistant applications/services include Microsoft® Cortana®, Apple® Siri®, Google Assistant® and Amazon® Alexa®, among other examples. Routine operation and implementation of virtual assistants are known to one skilled in the field of art. When a virtual assistant is natively installed on a computing device, interactions between a user and the virtual assistant may occur through a user interface of the virtual assistant. However, examples described herein are not so limited, where programmed skill(s) for meeting management enable a virtual assistant to interact with a user through a user interface of a virtual assistant, other communication modalities (e.g., messaging, SMS messaging, e-mail messaging) as well as directly through conferencing applications/services, among other examples.

A non-limiting example of the present disclosure relates to programmatically issuing, through an exemplary virtual assistant service, a communication that enables automatic connection of a user to a conferencing session for a meeting, for example, when the scheduled meeting starts. Electronic conferencing details, for a scheduled meeting, are extracted from an electronic meeting invite. An occurrence of the scheduled meeting is detected based on an analysis of the extracted conferencing details. A communication is issued, based on the detected occurrence, to a user computing device through a user interface of an exemplary virtual assistant. An exemplary communication comprises a call communication for connecting a user computing device to a conferencing session associated with the scheduled meeting. In one example, the call communication is voice over internet protocol (VoIP) data in any form. This may include video conferencing communications, group conferencing calls and other internet protocol (IP) telephony examples as known to one skilled in the field of art. In alternative examples, the call communication is a call bridged from a public switched telephone network (PSTN). Further examples of modalities of an exemplary call communication comprise but are not limited to: group messaging, instant messaging (IM), chat rooms, forums, and social networking channels, among other examples.

In some examples, an exemplary communication is issued through a user interface of a virtual assistant. The communication may further comprise chat dialogue directed issued from the virtual assistant to a meeting attendee of the electronic meeting invite. However, as referenced in the foregoing, some service-based examples do not limit communications to be issued directly through a user interface of a virtual assistant. In further examples, an exemplary communication may be multiple communications that may be programmatically issued to a user computing device across different modalities. For instance, a phone number or email address that is registered with the virtual assistant service may receive one or more message notifications and a call communication may separately be issued via a communication application/service.

A user may automatically connect to an exemplary conferencing session, for the scheduled meeting, based on an acceptance of the call communication through the user computing device. In one example, the virtual assistant service initiates, on behalf of the user computing device, a call communication based on the extracted conferencing details. The call communication may be forwarded to the user computing device to connect a user to a conferencing session for the scheduled meeting. For instance, an exemplary communication may comprise the forwarded call communication, which when accepted, directly connects the user computing device to the conferencing session. The virtual assistant both proactively calls a user computing device as well as acts as a passive participant in an exemplary conferencing session. Programmed skills(s) for meeting management, associated with an exemplary virtual assistant service, may enable a user to set rules for initiating communications with a user. For example, the virtual assistant service may connect to a conferencing session and see if meeting attendees are on the line before initiating a call communication to the user computing device. In another example, the virtual assistant may be configured to ask if the user is ready for the scheduled meeting and enable the user to provide a command (e.g., spoken utterance or input through another known modality) for instructing the virtual assistance service on when to call the user. Such processing operations are not limited to examples in which a user sets rules for operation. Exemplary programmed skill(s) for meeting management may be configured to automatically execute such operations on behalf of a user. For instance, a trigger for initiating a call communication on behalf of a user may be a detected instance when another meeting attendee joins an exemplary conferencing session.

In further examples, the virtual assistant may be added to the conferencing session, for example, to enable meeting attendees to communicate with the virtual assistant directly through the conferencing session. As an example, meeting attendee status may be detected and provided to user computing devices. In other instances, commands or instructions can be directed to the virtual assistant via the conferencing session. In an alternative example, a meeting invitee may wish to communicate a message to meeting attendees via the virtual assistant, where the virtual assistant (as a bot agent attending the meeting) is able to relay the message to the meeting attendees.

In any example, interactions between a virtual assistant service and a user computing device are improved by extending functionality of a virtual assistant to execute new processing operations. Furthermore, interactions between a virtual assistant service and a user computing device are also improved through the provision of an enhanced user interface of a virtual assistant that improves processing efficiency and usability over previously existing graphical user interfaces (GUIs). Previous versions of virtual assistant application/services have not been configured to interface with other application/services to enable automated meeting connection nor the ability for a virtual assistant to interact with meeting attendees during a live conferencing session. Further drawbacks of previously existing GUIs include a lack of interfacing with applications/services such as calendaring/scheduling applications/services and web conferencing applications/services to enable functionality described herein. An exemplary virtual assistant may interface with a bot framework component, language understanding component, meeting scheduling component, meeting connection component and other applications/services of (e.g., of an application platform) to adapt a GUI for contextual understanding and communications to manage meetings. Non-limiting GUI examples and other service examples (e.g., of an exemplary virtual assistant service) are illustrated in (and subsequently described in the description of) FIGS. 3A-3I.

Exemplary technical advantages provided by processing described in the present disclosure including but are not limited to: extending functionality of a virtual assistant to enhance meeting management and connection, thus providing more intelligent and capable virtual assistant services; generation of exemplary skill(s), that can be integrated with application/service such as a virtual assistant, providing meeting management functionality described herein; ability to extend, through a virtual assistant service, virtual assistant functionality to user computing devices that may not have virtual assistant software natively installed; an ability to automate connection of a user computing device with a conferencing session via an exemplary virtual assistant; ability to add virtual assistant bot to conferencing session to provide on-call virtual assistant functionality; improved processing efficiency during for computing devices and application/service during execution of processing relating to meeting connection and execution; reduction in latency in establishing a connection to a conferencing session of a scheduled meeting; an improved user interface for exemplary applications/services (e.g., virtual assistant) that leads to improved user interaction and productivity for users of computing devices; improved processing efficiency (e.g., reduction in processing cycles and better resource management) for computing devices executing processing operations described herein, for example, through service-based integration of resources of an application platform; and improved system/service examples that extend capabilities and functionality of associated applications/services, among other technical advantages.

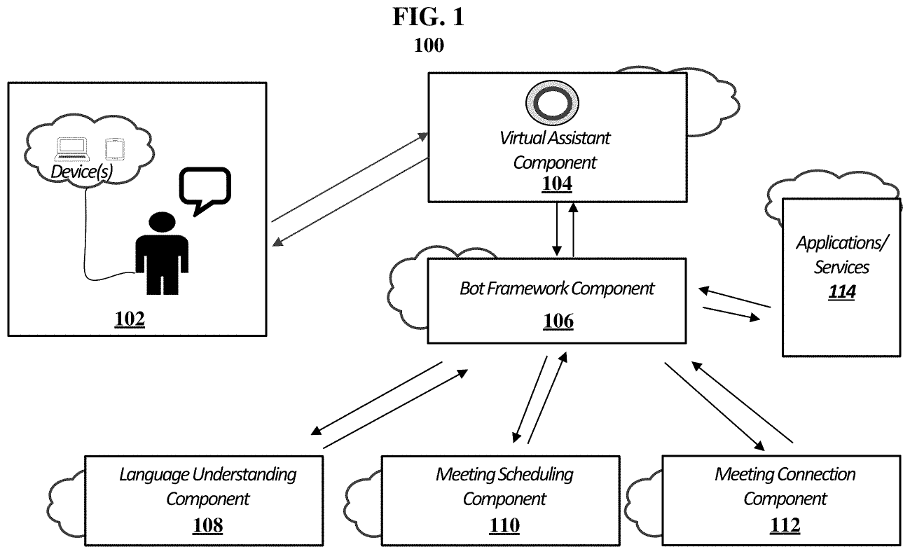

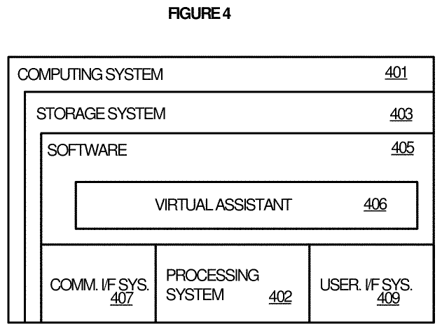

FIG. 1 illustrates an exemplary process flow 100 providing exemplary components for meeting management through an exemplary virtual assistant, with which aspects of the present disclosure may be practiced. As an example, components of process flow 100 may be executed by an exemplary computing system (or computing systems) as described in the description of FIG. 4. Exemplary components, described in process flow 100, may be hardware and/or software components, which are programmed to execute processing operations described herein. In one example, components of process flow 100 may each be one or more computing devices associated with execution of a specific service. Exemplary services may be managed by an application platform that also provides, to a component, access to and knowledge of other components that are associated with applications/services. In one instance, processing operations described in process flow 100 may be implemented by one or more components connected over a distributed network. Operations performed in process flow 100 may correspond to operations executed by a system and/or service that execute computer programs, application programming interfaces (APIs), neural networks or machine-learning processing, language understanding processing, search and filtering processing, and generation of content for presentation through a user interface of an application/service, among other examples.

Process flow 100 comprises a user computing device 102 (e.g., client computing device). An example of a user computing device 102 is a computing system (or computing systems) as described in the description of FIG. 4. A user may interact with an exemplary virtual assistant (or the virtual assistant is configured to proactively communicate with the user) through the user computing device 102 or a plurality of user computing devices. For instance, the user may connect to a virtual assistant application/service through any number of different device modalities. In some examples, a user may connect to an application/service (e.g., a virtual assistant service) through different user computing devices 102, where non-limiting examples of such are: a smart phone, a laptop, a tablet, a desktop computer, etc. In other instances, a user may carry on a multi-modal communication with a virtual assistant via multiple user computing devices. For example, a user may be communicating with a virtual assistant via a laptop or tablet and further connect to a conferencing session (of a scheduled meeting) via a mobile computing device such as a cellular phone or smartphone. An exemplary meeting is an assembly of two or more participants, where meetings can be conducted in-person, over the phone, online, group messaging, instant messaging, chat rooms, forums, social networking channels, through messaging applications/services, video call communications, etc., among other meeting forums as known to one skilled in the field of art.

The virtual assistant component 104 is configured to implement a virtual assistant application/service. A virtual assistant is a software agent that can perform tasks or services on behalf of a user. Virtual assistant services operate to keep users informed and productive, helping them get things done across devices and platforms. Commonly, virtual assistant services operate on mobile computing devices such as smartphones, laptops/tablets and smart electronic devices (e.g., speakers). Real-world examples of virtual assistant applications/services include Microsoft® Cortana®, Apple® Siri®, Google Assistant® and Amazon® Alexa®, among other examples. Routine operation and implementation of virtual assistants are known to one skilled in the field of art. When a virtual assistant is natively installed on a computing device, interactions between a user and the virtual assistant may occur through a user interface of the virtual assistant. However, examples described herein are not so limited, where programmed skill(s) for meeting management enable a virtual assistant to interact with a user through a user interface of a virtual assistant, other communication modalities (e.g., messaging, SMS messaging, e-mail messaging) as well as directly through conferencing applications/services, among other examples. The virtual assistant component 104 may comprise more than one component, where some of the processing for a virtual assistant service occurs over a distributed network. For instance, a spoken utterance may be received through a user interface, executing on the user computing device, and propagated to other components (of the virtual assistant or another service) for subsequent processing. In other examples, a virtual assistant component 104 is configured to implement a virtual assistant service that executes processing operations described herein over a network connection (e.g., distributed network).

An exemplary virtual assistant is configured to interface with other applications/services of an application platform to enhance contextual analysis of a spoken utterance as well as task execution by the virtual assistant on behalf of a user. An exemplary application platform is an integrated set of custom applications/services operated by a technology provider (e.g., Microsoft®). Applications/services, executed through an application platform, may comprise front-end applications/services, that are accessible by customers of an application platform. Applications/services (e.g., executed through an application platform) may also comprise back-end applications/services, that may not be accessible to customers of the application platform, which are used for development, production and processing efficiency. For instance, when a query or command is received, through a user computing device 102, a virtual assistant service is configured to interface with a language understanding service to provide trained language understanding processing. The virtual assistant component 104 also interfaces with other components of process flow 100 such as: the bot framework component 106 to generate dialogue flow for communicating with a user; and applications/services 114 that are utilized to obtain desired data/information and/or used for task execution.

As referenced in the foregoing, an exemplary virtual assistant, provided through the virtual assistant component 104, is newly configured to execute processing operations to enhance processing efficiency for meeting connection and execution. Processing operations that enable an exemplary virtual assistant to understand context for a meeting invite and execute new functionality, on behalf of a user, such as automatically calling a user to connect the user to a meeting when the meeting begins. This eliminates the need for a user to have to manually attempt to connect to a meeting. The virtual assistant component 104 is configured to execute one or more programmed skills for meeting management that adapts operation of the virtual assistant to enable users to utilize the virtual assistant with meeting scheduling and meeting execution. An exemplary skill may be programmed into executing code of the virtual assistant or be an add-on that connects to a virtual assistant application/service through an application programming interface. Programmed skills may be used to add new functionality to the virtual assistant as well as adapt a user interface (GUI) of the virtual assistant to accommodate the added functionality. Exemplary skills for meeting management provide a layer of intelligence over raw application data where a virtual assistant extracts electronic meeting details from an electronic meeting invite and utilizes the extracted meeting details to execute tasks for user assistance.

Non-limiting examples of tasks that may be executed, based on implementation of programmed skills for meeting management, comprise but are not limited to: automatically calling a user computing device when a meeting starts; meeting attendee detection (including status of meeting attendees in a conferencing session); ability to interface with messaging applications/service and/or email application/services to extend functionality of a virtual assistant to computing devices that may not have virtual assistant software installed; and extension of virtual assistant functionality during a live conferencing session, among other examples. In one example, a virtual assistant is added as a participant in a conferencing session (e.g., phone, videotelephony) where a user can interface with the virtual assistant directly in a meeting forum. Such interactions may directly result in controlling parameters of a conferencing session. In other examples, a user may interface with a user interface of the virtual assistant, through a user computing device, to provide updates or commands for controlling parameters of a conferencing session.

Moreover, the virtual assistant component 104 interfaces with an exemplary bot framework component 106. The bot framework component 106 acts as an interface between system components such as the virtual assistant component 104, the language understanding component 108, the meeting scheduling component 110, the meeting connection component 112 and other application/services 114. At various points in processing, the bot framework component 106 may receive processing from other components and propagate subsequent processing to the other components to realize programmed skills of the virtual assistant. The bot framework component 106 is utilized to convert data to a form that is usable by other applications/services. This may be accomplished through application programming interfaces (APIs), as a non-limiting example.

The bot framework component 106 implements an intelligent chat bot, for example, that is executed through a virtual assistant application/service. The intelligent chat bot enables dialogue to be established, through an exemplary virtual assistant service, to communicate with a user when a spoken utterance is directed to recall of user-specific usage data of an application/service. An exemplary bot framework component 106 is used to build, connect, deploy, and manage an exemplary intelligent (chat) bot. In doing so, the bot framework component 106 implements a bot framework. The bot framework provides software development kits/tools (e.g., .NET SDK and Node.js SDK) that assists developers with building and training an intelligent (chat) bot. The bot framework implements an exemplary software development kit that provides features, such as dialogs and built-in prompts, which make interacting with users much simpler. For example, developers can design questions, response prompts, tailoring of returned results with dialogue and any other dialogue-based flow to communicate with a user.

An exemplary intelligent bot may further be utilized to define process flow for processing of a spoken utterances, execution of tasks for meeting management as well as responses and follow-up dialogue with a user (through an exemplary user computing device). including interfacing with other applications/services. Furthermore, an exemplary intelligent bot may be trained to recognize patterns in speech to assist in language understanding processing. The intelligent bot interfaces with the other components of process flow 100 to generate dialogue and process flow for dialogue processing to enable a most appropriate response to be generated through a user interface based on a context in which the virtual assistant is executing (e.g., providing dialogue responses, executing tasks/actions). In one instance, the intelligent bot is programmed to assist with dialogue for processing operations related to but not limited to: detection of a user intent; identification of entity information; detection of occurrence of an event (e.g., start of a scheduled meeting); detection of user statuses (e.g., of meeting attendees); connecting to a conferencing session; sending exemplary communications; communicating with messaging applications/service and recording or transcribing an exemplary conferencing session, among other examples. In some examples, the bot framework component 106 is configured to provide pre-programmed messages that correspond to specific actions for meeting management (e.g., connection to a conferencing session, meeting attendee detection status, in-call communication during a conferencing session).

An exemplary language understanding component 108 is configured to implement a language understanding service to generate language understanding processing results for the virtual assistant component 104. Language understanding processing may be executed for spoken utterances based on interactions between a user and a virtual assistant. As referenced above, some examples of processing do not require language understanding processing. Language understanding processing results may be propagated to other components of process flow 100 (e.g., applications/service 114) to enhance processing thereof. For instance, exemplary language understanding processing results may be propagated to the bot framework component 106, which may then propagate/forward the results, to other components of process flow 100. Execution of language understanding processing is known to one skilled in the field of art. As non-limiting examples, language understanding processing may comprise but is not limited to: prosodic and lexical evaluation of the spoken utterance; converting the spoken utterance to text (for subsequent processing); determining an intent associated with a spoken utterance; entity identification; part-of-speech slot tagging; and processing of associated signal data (e.g., device, user account, application/service), among other processing operations. Format of language understanding processing results may vary in accordance with the knowledge of one skilled in the field of art. As a non-limiting example, a spoken utterance may be received as a hypertext transfer protocol (HTTP) request, where an exemplary language understanding model is applied to evaluate the HTTP request. In a further non-limiting example, processing, by the language understanding component 108, may create language understanding processing results in a different format such as a JavaScript object notation (JSON) object. In any example, language processing results may be generated in a format that enables applications/services to execute subsequent processing.

The virtual assistant component 104 may interface with the meeting scheduling component 110 to execute operations related to a programmed skill for meeting management. In doing so, an exemplary meeting scheduling component 110 is configured to manage an electronic meeting invite for a scheduled meeting. The meeting scheduling component 110 may interface with exemplary application/services 114 to enable connection with specific applications/services for accessing electronic meeting invites. Exemplary applications/services 114 may comprise application/services of an application platform as well as third-party applications/services including those subsequently described. An electronic meeting invite is a digital meeting invitation for a subsequently scheduled meeting. Electronic meeting invites may be generated and presented through any type of application/service including but not limited to: email applications/services, calendaring applications/services, messaging applications/services, electronic meeting scheduling applications/services, call communication applications/services and web conferencing applications/services, among other examples. An example of an electronic meeting invite is a meeting invitation, generated and surfaced through a GUI of Microsoft® Outlook®, that invites one or more persons to an VoIP meeting (e.g., Skype®) or conferencing session via a telephone network service (e.g., PSTN).

The electronic meeting invite is an invitation to join a conferencing session at subsequently scheduled meeting time. An electronic meeting invite is provided, through an application/service, to more than one meeting participant (e.g., person, group/team, bot, agent). A conferencing session connects the meeting participants for communication at the scheduled meeting time. An exemplary conferencing session may occur, in real-time or near real-time, over an internet protocol (e.g., VoIP conferencing session) or telephone network (e.g., public switched telephone network (PSTN)). An exemplary virtual assistant may be added to an electronic meeting invite either directly as a participant or via forwarding of a created electronic meeting invite to the virtual assistant. As an example, a user, via user computing device 102, may create an electronic meeting invite and add an alias (e.g., email address) to the meeting invite. In another example, a user, via the user computing device 102, may forward a received meeting invite to the virtual assistant. In a further example, the user may select a user interface feature within an application/service, which triggers tracking of the electronic meeting invite by the virtual assistant. In yet another example, a user may initiate a communication with the virtual assistant, through the user computing device 102, that asks the virtual assistant to track a specific electronic meeting invite. This may be a trigger for execution of processing operations described herein, including but not limited to automatic initiation of a call communication for a conferencing session of a scheduled meeting.

In any example where the virtual assistant is added to evaluate an electronic meeting invite, the meeting scheduling component 110 is configured to interface with the virtual assistant component 104 for providing access to details of an electronic meeting invite for subsequent parsing and analysis. An exemplary programmed skill for meeting management may comprise processing operations that identify an electronic meeting invite, parse the electronic meeting invite and extract electronic conferencing details from the parsed meeting invite. In some examples, the virtual assistant component 104 is configured to execute processing operations for parsing and analyzing an electronic meeting invite. In alternative examples, the virtual assistant component 104 interfaces with other applications/services to execute processing operations for parsing and analysis of an electronic meeting invite.

Electronic conferencing details may vary depending on the type of application/service in which the electronic meeting invite is generated. Exemplary electronic conferencing details may comprise but are not limited to: meeting invitees (and associated contact data/profile data); meeting attendees (and associated contact data/profile data); meeting subject; meeting location; meeting duration (including start time and end time); application/service hosting scheduled meeting/conferencing session; uniform resource identifier (URI)/link to access conferencing session of scheduled meeting; phone number(s) for access to conferencing session of scheduled meeting; country codes for call connection; conference ID number(s) for connecting to conferencing session; personal identification (PIN) number(s) for connecting to conferencing session; identification of attachments; identification of meeting notes; and identification of related messaging threads, comments, etc., among other examples.

An exemplary API may be programmed to parse and extract specific electronic conferencing details from an electronic meeting invite. In some examples, a machine learning model may be trained and employed for the collection and analysis of electronic conferencing details. General creation and implementation of a machine learning model is known to one skilled in the field of art, where a machine learning model may be further adapted to the specifics of extraction and evaluation of exemplary electronic conferencing details. For example, a machine learning model may be implemented to contextually analyze extracted electronic conferencing details and generate determinations that a virtual assistant may utilize to execute tasks on behalf of a user. In doing so, the virtual assistant may act as an agent on behalf of a user to execute tasks such as automatically initiating a call communication for a user to join a conferencing session of a meeting. Exemplary determinations, generated by machine learning processing, may correlate to tasks executed for various programmed skills for meeting management. For instance, generated determinations may correlate to specific electronic meeting details, where the generated determinations may be used for task execution at the appropriate time. Examples of such tasks comprise but are not limited to: automatically calling (e.g., initiating a call communication) a user computing device when a meeting starts; ability to update an electronic meeting invite; meeting invitee status detection; meeting attendee detection (including status of meeting attendees in a conferencing session); ability to interface with messaging applications/services (e.g., provide messaging to computing devices across different modalities); and extension of virtual assistant functionality during a live conferencing session, among other examples. Execution of exemplary tasks may be coded (e.g., through an API or application code/software kit) to programmatically occur based on various triggers including but not limited to: adding a virtual assistant to an electronic meeting invite; detection of an occurrence of a scheduled meeting; receipt of a command (e.g., voice, text, handwritten input) requesting execution of a task; and connection to an exemplary conferencing session, among other examples.

An exemplary meeting connection component 112 is configured to initiate connection to an exemplary conferencing session, on behalf of the user computing device 102, as well as manage connection of an exemplary virtual assistant with the conferencing session. To initiate connection to an exemplary conferencing session, the virtual assistant component 104 may interface with exemplary applications/services configured for hosting a conferencing session for a scheduled meeting as well as application/services configured for establishing call communications. Non-limiting examples of applications/services configured for hosting a conferencing session may comprise but are not limited to: call communication applications/services; email applications/services; social networking applications/services; messaging applications/services; telecommunication applications/services; web conferencing applications/services; and other productivity applications/services, among other examples. A programmed skill for programmatic initiation of a call communication, on behalf of a user, may be configured to work with any type of application/service that is used for establishing a conferencing session, where extracted conferencing details may be utilized to establish an active call communication on behalf of a user.

Examples of applications/services configured for establishing call communications may comprise similar applications/services to those listed in the foregoing as well as telecommunication platforms and communication platforms as a service (PaaS; cloud-based communication platforms), among other examples. An example of a PaaS is Twilio®, which enables developers to programmatically make, receive and forward phone calls as well as send and receive messages using web service APIs. In one example, a scheduled meeting may be set to occur through a call communication application/service such as Skype® or a web conferencing application/service such as WebEx®, GoToMeeting®, Citrix®, where the virtual assistant component 104 may also interface with a PaaS such as Twilio® to establish a call communication via internet protocol (IP) telephony or public switched telephone network (PSTN). For instance, a call communication may be established with a call communication application/service or web conferencing application/service, via IP telephony or phone number (via PSTN). The virtual assistant component 104 is configured to forward the established call communication to the user computing device 102, for example, through the user interface of the virtual assistant. To enable call forwarding functionality, an exemplary API may be programmed to enable interfacing between one or more applications/services of an application platform (e.g., virtual assistant) with an exemplary communication PaaS (e.g., Twilio®).

The meeting connection component 112 may utilize generated determinations, from the meeting scheduling component 110, to execute exemplary tasks, which are referenced in the foregoing description. In one example, the meeting connection component 112 may execute processing operations for detecting an occurrence of a scheduled meeting, which may be a trigger for initiating a task of connecting a user computing device 102 to an exemplary conferencing session. An occurrence of a scheduled meeting may be detected based on an analysis of extracted conferencing details from an exemplary electronic meeting invite. For example, electronic conferencing details are analyzed to identify date and time of a scheduled meeting (e.g., time stamp), which are utilized to known when to initiate processing operations for initiating connection to a conferencing session. In some examples, determinations for meeting initiation are generated prior to occurrence of the scheduled meeting, where the virtual assistant is programmed to execute processing operations for meeting initiation at the scheduled meeting time. An exemplary virtual assistant may be programmed, through a skill for meeting management, to detect the occurrence of the scheduled meeting and execute processing operations to initiate a conferencing session (e.g., using a phone number, URI, conferencing IDs, PIN number) and forward the initiated conferencing session to the user computing device 102, for example, through issuance of an exemplary communication.

An exemplary communication comprises a call communication for connecting a user computing device to a conferencing session associated with the scheduled meeting. In one example, the call communication is voice over internet protocol (VoIP) data in any form. This may include video conferencing communications, group conferencing calls and other internet protocol (IP) telephony examples as known to one skilled in the field of art. In alternative examples, the call communication is a call bridged from a public switched telephone network (PSTN). Further examples of modalities of an exemplary call communication comprise but are not limited to: group messaging, instant messaging (IM), chat rooms, forums, and social networking channels, among other examples. The communication may further comprise chat dialogue directed issued from the virtual assistant to a meeting attendee of the electronic meeting invite. However, as referenced in the foregoing, some service-based examples do not limit communications to be issued directly through a user interface of a virtual assistant. In further examples, an exemplary communication may be multiple communications (e.g., series of communications) that may be programmatically issued to a user computing device across different modalities. For instance, a phone number or email address that is registered with the virtual assistant service may receive one or more message notifications and a call communication may separately be issued via a communication application/service.

An exemplary communication may be programmatically created and issued through the meeting connection component 112, for example, through interfacing with an exemplary bot framework component 106 and the virtual assistant component 104, which enables chat dialogue to be generated as well as interfacing with application/services to connect a user computing device 102 to a conferencing session. In one example, the virtual assistant initiates, on behalf of the user computing device, a call communication based on the extracted conferencing details. The call communication may be forwarded to the user computing device to connect a user to a conferencing session. For instance, an exemplary communication, issued through a user interface of the virtual assistant, may comprise the forwarded call communication.

In further examples, the meeting connection component 112 is configured to extend virtual assistant functionality during a live conferencing session. For example, through interfacing with a combination of components of process flow 100 (e.g., the virtual assistant component 104, the bot framework component 106, applications/services 114), an exemplary virtual assistant is configured to act as an agent on behalf of one or more users. For instance, exemplary programmed skills for meeting management may be configured to enable a virtual assistant to execute processing operations for joining a conferencing session and assist meeting attendees. In one example, a virtual assistant is added as a participant in a conferencing session (e.g., phone, videotelephony) where a user can interface with the virtual assistant directly in a meeting forum. Such interactions may directly result in controlling parameters of a conferencing session. In a further example, an exemplary virtual assistant is configured to execute meeting attendee detection including detection and reporting of statuses of meeting attendees in a conferencing session. In other examples, a user may direct a virtual assistant to record or transcribe a conferencing session on behalf of a user. Such actions may occur in accordance with privacy laws and user consent regulations associated with usage of a specific conferencing application/service.

In other examples, a user may interface with a user interface of the virtual assistant, through a computing device (e.g., user computing device 102), to provide updates or commands for controlling parameters of a conferencing session. For instance, a user may provide a command, directly through a communication line of a conferencing session, that is directed to a virtual assistant for the virtual assistant to execute a task on behalf of a user. In alternative examples, a user may interface with a user interface of the virtual assistant, through a user computing device, to provide updates or commands for controlling parameters of a conferencing session. For instance, a user may be late to a scheduled meeting and request that the virtual assistant update other meeting attendees. This becomes more feasible when the virtual assistant is a participant in a conferencing session as opposed to the virtual assistant application/service having to identify individual attendees and accounts associated with individual attendees. The bot framework component 106 may utilize an intelligent bot to generate dialogue that accompanies communication of the virtual assistant through different applications/services such as those used for active conferencing sessions.

The virtual assistant both proactively calls a user computing device as well as acts as a passive participant in an exemplary conferencing session. Programmed skills(s) for meeting management, associated with an exemplary virtual assistant service, may enable a user to set rules for initiating communications with a user. For example, the virtual assistant service may connect to a conferencing session and see if meeting attendees are on the line before initiating a call communication to the user computing device. In another example, the virtual assistant may be configured to ask if the user is ready for the scheduled meeting and enable the user to provide a command (e.g., spoken utterance or input through another known modality) for instructing the virtual assistance service on when to call the user. Such processing operations are not limited to examples in which a user sets rules for operation. Exemplary programmed skill(s) for meeting management may be configured to automatically execute such operations on behalf of a user. For instance, a trigger for initiating a call communication on behalf of a user may be a detected instance when another meeting attendee joins an exemplary conferencing session.

As referenced above, exemplary applications/services 114 may interface with other components of process flow 100 to enhance processing efficiency and functionality of a virtual assistant when executing programmed skills for meeting management. For instance, specific components of process flow 100 may each be associated with one or more application/services to enable functionality of each of the components. Applications/services 114 may be any type of programmed software designed to perform a group of coordinated functions, tasks, or activities for the benefit of the user. An exemplary productivity application/service is an application/service configured for execution to enable users to complete tasks on a computing device, where exemplary productivity services may be configured for access to content including content retrieved via a network connection (e.g., Internet, Bluetooth®, infrared). For example, an exemplary application/service may be utilized to schedule a meeting

An example of an application/service 114 is a productivity application/service. Examples of productivity services comprise but are not limited to: word processing applications/services, spreadsheet applications/services, notes/notetaking applications/services, authoring applications/services, digital presentation applications/services, search engine applications/services, email applications/services, messaging applications/services, web browsing applications/services, collaborative team applications/services, digital assistant applications/services, directory applications/services, mapping services, calendaring services, electronic payment services, digital storage applications/services, web conferencing applications/services, call communication applications/services, language understanding applications/services, bot framework applications/services, networking applications/service, and social networking applications/services, among other examples. In some examples, an exemplary productivity application/service may be a component of a suite of productivity applications/services that may be configured to interface with other applications/services associated with an application platform. For example, a word processing service may be included in a bundled service (e.g. Microsoft® Office365® or the like). Further, an exemplary productivity service may be configured to interface with other internet sources/services including third-party application/services, for example, to enhance functionality of productivity services during execution of operations such as scheduling and reminders, establishing connection to a conferencing session and providing virtual assistant services during a conferencing session, among other examples.

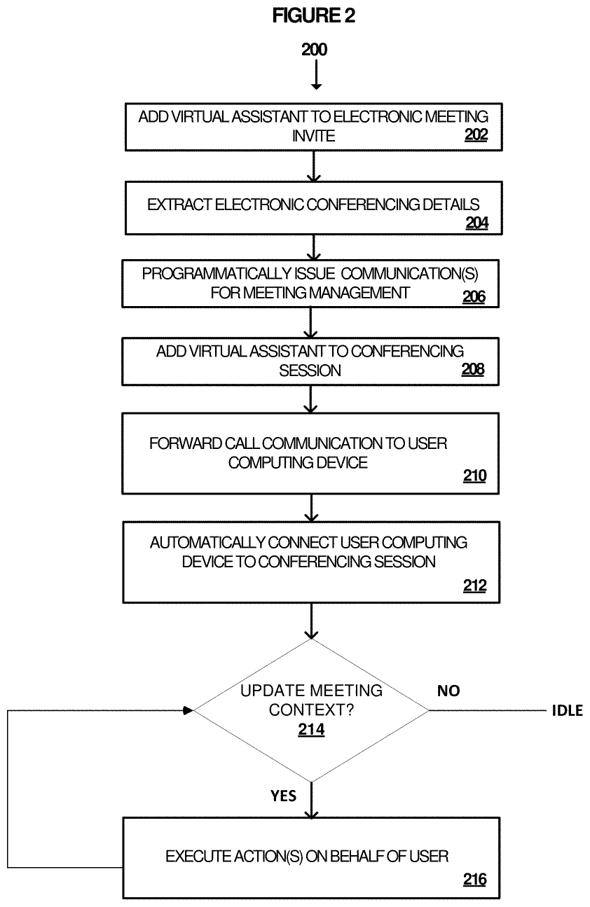

FIG. 2 illustrates an exemplary method 200 related to meeting management through an exemplary virtual assistant, with which aspects of the present disclosure may be practiced. Processing operations described in method 200 may be executed by components described in process flow 100 (FIG. 1), where the detailed description in process flow 100 supports and supplements the recited processing operations in method 200. Interfacing and communication between exemplary components, such as those described in process flow 100, are known to one skilled in the field of art. For example, data requests and responses may be transmitted between applications/services to enable specific applications/services to process data retrieved from other applications/services. Formatting for such communication may vary according to programmed protocols implemented by developers without departing from the spirit of this disclosure.

As an example, method 200 may be executed across an exemplary computing system (or computing systems) as described in the description of FIG. 4. Exemplary components, described in method 200, may be hardware and/or software components, which are programmed to execute processing operations described herein. Operations performed in method 200 may correspond to operations executed by a system and/or service that execute computer programs, software agents, intelligent bots, application programming interfaces (APIs), neural networks and/or machine-learning processing, among other examples. In some examples, processing operations described in method 200 may be executed by one or more applications/services associated with a web service that has access to a plurality of application/services, devices, knowledge resources, etc. In one instance, processing operations described in method 200 may be implemented by one or more components connected over a distributed network.

Method 200 begins at processing operation 202, where a virtual assistant application/service is added to an electronic meeting invite. An exemplary virtual assistant may be added to an electronic meeting invite through an application/service that enable scheduling of a meeting and transmission of electronic meeting invites. As referenced in the foregoing description, an exemplary virtual assistant may be added (processing operation 202) either directly as a participant on an electronic meeting invite or via forwarding of a created electronic meeting invite to the virtual assistant. As an example, a user may create an electronic meeting invite and add an alias (e.g., email address) to the meeting invite. In another example, a user, via a computing device, may forward a received meeting invite to the virtual assistant. In a further example, the user may select a user interface feature within an application/service, which triggers tracking of the electronic meeting invite by the virtual assistant. In yet another example, a user may initiate a communication with the virtual assistant, through a computing device, that asks the virtual assistant to track a specific electronic meeting invite. This may be a trigger for execution of processing operations described herein, including but not limited to automatic initiation of a call communication for a conferencing session of a scheduled meeting. In examples where a user adds an alias of a virtual assistant to a meeting invite (or associates a created meeting invite with the virtual assistant), an exemplary virtual assistant service may send or more messages to requesting that a user register a contact modality with the virtual assistant service. The contact modality may be used to communicate with the user to provide servicing for meeting management as described herein. Non-limiting examples of contact modalities comprise but are not limited to: e-mails; text messages; video or audio messaging; notifications (e.g., through an OS or application/service); instant messages; group messages; and reminders, among other examples. A user may register one or more contact modalities with the virtual assistant service. A non-limiting example of a message for registering a contact modality is provided in FIG. 3D.

Flow of method 200 proceeds to processing operation 204, where electronic conferencing details are extracted from the electronic meeting invite. Exemplary electronic conferencing details and processing related to extraction of electronic conferencing details has been provided in the foregoing description including the description of process flow 100 (FIG. 1). For example, an exemplary programmed skill for meeting management may be created for a virtual assistant. An exemplary programmed skill for meeting management may comprise processing operations that identify an electronic meeting invite, parse the electronic meeting invite and extract electronic conferencing details from the parsed meeting invite. In some examples, a virtual assistant component (e.g., virtual assistant component 104) is configured to execute processing operations for parsing and analyzing an electronic meeting invite. In alternative examples, a virtual assistant component interfaces with other applications/services to execute processing operations for parsing and analysis of an electronic meeting invite.

As referenced in the foregoing, an exemplary API may be programmed to parse and extract specific electronic conferencing details from an electronic meeting invite. In some examples, a machine learning model may be trained and employed for the collection and analysis of electronic conferencing details. Electronic conferencing details may vary depending on the type of application/service in which the electronic meeting invite is generated. Exemplary electronic conferencing details may comprise but are not limited to: meeting invitees (and associated contact data/profile data); meeting attendees (and associated contact data/profile data); meeting subject; meeting location; meeting duration (including start time and end time); application/service hosting scheduled meeting/conferencing session; uniform resource identifier (URI)/link to access conferencing session of scheduled meeting; phone number(s) for access to conferencing session of scheduled meeting; country codes for call connection; conference ID number(s) for connecting to conferencing session; personal identification (PIN) number(s) for connecting to conferencing session; identification of attachments; identification of meeting notes; and identification of related messaging threads, comments, etc., among other examples.

Flow of method 200 may proceed to processing operation 206, where an exemplary communication is programmatically issued through a virtual assistant service. An exemplary communication comprises a call communication for connecting a user computing device to a conferencing session associated with the scheduled meeting. Examples of call communications have been provided in the foregoing description. The communication may further comprise chat dialogue directed issued from the virtual assistant to a meeting attendee of the electronic meeting invite. However, as referenced in the foregoing, some service-based examples do not limit communications to be issued directly through a user interface of a virtual assistant. In further examples, an exemplary communication may be multiple communications that may be programmatically issued to a user computing device across different modalities. For instance, a phone number or email address that is registered with the virtual assistant service may receive one or more message notifications and a call communication may separately be issued via a communication application/service.

Visual examples of an exemplary communications are provided in FIGS. 3A-3I, for example, FIGS. 3E and 3F and 3I. In one example, an exemplary communication may be provided through a user interface of a virtual assistant, which enables chat dialogue to be generated as well as interfacing with application/services to connect a computing device (e.g., user computing device 102) with a conferencing session. In processing operation 206, the virtual assistant initiates, on behalf of the user computing device, a call communication based on the extracted conferencing details. For instance, the virtual assistant may interface with a communication application/service (e.g., PaaS for IP telephony or a PSTN) to establish a call communication (e.g., IP telephony) with a conferencing session (e.g., provided through a web conferencing application/service). That call communication may be forwarded (processing operation 210), via a user interface of the virtual assistant, to a user computing device for connecting a user to the conferencing session. A call communication may be in any form including traditional telephone call communication and video-conferencing call connection, among other examples previously described.

In some examples, method 200 may proceed to processing operation 208, where the virtual assistant is added as a participant in an exemplary conferencing session for a scheduled (or live) meeting. This may occur before or after a call communication is established in processing operation 206. In at least one example, the virtual assistant is added (processing operation 208) to the conferencing session and then forwards (processing operation 210) the call communication to user computing device. Adding a virtual assistant to a conferencing session enables the virtual assistant to be utilized during the conferencing session. In at least one example, a user may address the virtual assistant directly through a communication line of a conferencing session. In other instances, a user may provide commands for a virtual assistant, to act as an agent on behalf of the user, while joined on the conferencing session. In further examples, the virtual assistant may be added to the conferencing session, for example, to enable meeting attendees to communicate with the virtual assistant directly through the conferencing session. As an example, meeting attendee status may be detected and provided to user computing devices.

Flow of method 200 proceeds to processing operation 212, where a user computing device is automatically connected to an exemplary conferencing session for a meeting. As an example, processing operation 212 may connect a user computing device to a conferencing session when a user accepts a call communication through its computing device. In another example, an exemplary communication, provided through a user interface, may comprise a URI or link to connect to an exemplary conferencing session.

Flow may proceed to decision operation 214, where it is determined whether there is an update to a meeting context for a scheduled meeting or active conferencing session. A meeting context may comprise an update to an electronic meeting invite, for example, prior to occurrence of a scheduled meeting or a task execution request of the virtual assistant on behalf of a user (either during or after an exemplary conferencing session). For instance, a user may provide a command, through a virtual assistant application/service, to update other meeting attendees that the user is going to be late. In another example, a user may request that a virtual assistant lookup information/data while the conferencing session is active. In yet another example, a user may request that the virtual assistant execute a task such as transcribe or record the conferencing session.

In examples where no update occurs, flow of decision operation 214 branches NO and processing of method 200 remains idle until subsequent processing is to occur. In examples where a meeting context is to be updated, flow of decision operation 214 branches YES and processing proceeds to processing operation 216. At processing operation 216, an action is executed, by the virtual assistant, on behalf of a user. Flow of method 200 may return back to decision operation 214 to determine if there is any subsequent update to the meeting context.

FIGS. 3A-3I illustrate exemplary processing device views providing exemplary interactions of a virtual assistant service, with which aspects of the present disclosure may be practiced. Processing operations described in process flow 100 (FIG. 1) and method 200 (FIG. 2) support and supplement back-end processing used for generation of exemplary processing device views shown in FIGS. 3A-3I.

FIG. 3A illustrates processing device view 300, illustrating a message that provides a user with a notification 302 of new functionality associated with an exemplary virtual assistant. Exemplary new functionality may pertain to programmed skill(s) for meeting management as described in the foregoing description. Notification 302 may be issued through an exemplary application/service including but not limited to an email application/service, a messaging application/service, a virtual assistant application/service, a calendaring application/service and through an operating system (OS), among other examples. Notification 302 highlights an alias of a virtual assistant, that a user can add to an electronic meeting invite, for activation of exemplary programmed skills for meeting management.

FIG. 3B illustrates processing device view 320, illustrating an interaction with a user, through a user computing device, during creation of an exemplary electronic meeting invite 322. In the example shown in processing device view 320, a user adds an exemplary alias of a virtual assistant 324 as an invitee for the electronic meeting invite 322. Alternatively, as referenced in the foregoing description, the electronic meeting invite 322 may be forwarded to a virtual assistant, for example, using the alias of the virtual assistant 324 as a recipient of a forwarded electronic meeting invite. Furthermore, the electronic meeting invite 322 comprises electronic conferencing details 326 that may be extracted from the electronic meeting invite 322. Examples of electronic conferencing details 326 comprise: meeting invitee contact information, meeting location, date/time of the meeting, a modality for connecting to meeting (e.g., Skype®), a phone number for joining an exemplary conferencing session, a conference ID and a PIN.

FIG. 3C illustrates processing device view 330, illustrating a notification 332 provided to a user, through a user computing device. Notification 332 may be provided to a user after associating an exemplary alias of a virtual assistant 324 (FIG. 3B) with an electronic meeting invite. Notification 332 may be issued through an exemplary application/service including but not limited to an email application/service, a messaging application/service, a virtual assistant application/service, a calendaring application/service and through an operating system (OS), among other examples. An exemplary notification 332 indicates that a user is to register a telephone number with a virtual assistant application/service so that the virtual assistant can initiate connection between the user and a conferencing session for a scheduled meeting. The notification 332 further comprises an exemplary link 334, where selection of link 334 may navigate the user to a webpage for registering a phone number with the virtual assistant.

FIG. 3D illustrates processing device view 340, which is a continued example of processing device view 330 (FIG. 3C). In the example shown in processing device 340, a user may register a telephone number (or multiple phone numbers) with a virtual assistant application/service. This may enable a virtual assistant service to communicate directly with a user computing device even in examples where virtual assistant software is not natively installed on the user computing device. Processing device view 340, illustrated in FIG. 3D, may be accessed via link 334 (FIG. 3C) or via a user entering the web address shown in notification 332 (FIG. 3C). For instance, a user may utilize a web browser to access an interface for a virtual assistant service. The graphical user interface elements 342, for entry of a phone number, is provided through a web browsing application/service. In alternative examples (not shown), a user may be given the option to register other modalities for communication such as an e-mail address or provide multiple different types of modalities for a virtual assistant service to communicate with a user. In further alternative examples, an exemplary interface for a virtual assistant service may be configured to enable users to set specific rules, alerts, notifications, etc.

FIG. 3E illustrates processing device view 350, illustrating an exemplary communication provided by a virtual assistant. Exemplary communications have been described in the foregoing description. In the example shown in processing device view 350, an exemplary communication is provided to initiate a conferencing session, through a user computing device, on behalf of a user. The exemplary communication comprises chat dialogue 352, provided through a user interface of an exemplary virtual assistant. The chat dialogue 352 provides context for the user. In the example shown, a user may programmatically receive an exemplary communication, for example, at the time a conferencing session is scheduled to begin for a scheduled meeting. An exemplary communication further comprises a call communication 354, that is utilized to connect the user computing device to a conferencing session of a scheduled meeting. The call communication 354 is just one example of how a virtual assistant may connect a user to a conferencing session. A user, through a GUI (OS) of the user computing device or a GUI of the virtual assistant, may select a UI feature for accepting or declining the call communication. Acceptance of the call communication triggers automatic connection to an exemplary conferencing session, without the user having to locate conferencing details and manually attempt to connect to a conferencing application/service.

FIG. 3F illustrates processing device view 360, which is a continued example of processing device view 350 (FIG. 3D). Processing device view 360 illustrates connection to an exemplary conferencing session (for a scheduled meeting) 364, for example, via acceptance of call communication 354 (FIG. 3E). Furthermore, processing device view 360 illustrates an updated chat dialogue 362, indicating to a user that the user has joined an active conferencing session for the meeting.

FIG. 3F illustrates processing device view 370, providing an example of a user interaction with a virtual assistant. In the example shown in processing device view 370, a user may provide a command 372 (e.g., through spoken utterance of device input) requesting that the virtual assistant execute a task on behalf of the user. As referenced in the foregoing description, an exemplary virtual assistant is enhanced through the implementation of exemplary programmed skill(s) for meeting management. This enables the virtual assistant to execute tasks for meeting management on behalf of the user. For instance, electronic conferencing details (of an electronic meeting invite) may be extracted and analyzed to enable the virtual assistant to understand a meeting context for a scheduled meeting. When a user provides command 372, requesting the virtual assistant to notify meeting attendees that the user will be late, the virtual assistant may interface with other processing components (e.g., described in process flow 100 of FIG. 1) to generate a chat dialogue response to the user-issued command 372.

In processing device view 370, a first response 374 is provided, by the virtual assistant, through the GUI of the virtual assistant. The first response 374 provides confirmation that the virtual assistant has received command 372. The first response 374 is displayed through a display of a user computing device. The virtual assistant may interface with one or more other applications/services to execute processing operations that completes a task (or tasks) determined from the received command 372. Processing operations related to execution of tasks through a virtual assistant are known to one skilled in the field of art. In one instance, a virtual assistant may utilize extracted conferencing details to join a conferencing session and provide a message to the meeting attendees. In another instance, the virtual assistant may utilize extracted conferencing details to provide a message (e.g., SMS or email) to other meeting invitees associated with an electronic meeting invite. Once an executed task (or tasks) is completed, the GUI of the virtual assistant may update to provide a second response 376, which is used to inform the user that a requested action/task is completed.

FIG. 3H illustrates processing device view 380, providing an example of a user interaction with a virtual assistant. In the example shown in processing device view 380, an exemplary virtual assistant provides a proactive notification 382 to the user through a GUI of the virtual assistant. The proactive notification 382 may be displayed via a user computing device (or attached display or peripheral device), providing a reminder of a scheduled meeting. For instance, as described herein, an exemplary virtual assistant may analyze conferencing details of an electronic meeting invite to generate one or more reminders of a scheduled meeting.

FIG. 3I illustrates processing device view 390, which is a continued example of processing device view 340 (FIG. 3D). In processing device view 340, a user may register a phone number (or other form of contact modalities) so that an exemplary virtual assistant service may communicate with a user to execute functionality described herein. This communication may occur even in instances where a computing device does not have exemplary virtual assistant software natively installed. An exemplary virtual assistant service may communicate with a user via a contact modality (or multiple contact modalities) as selected by a user. Examples of contact modalities comprise but are not limited to: e-mail messages; text messages; video or audio messaging; notifications (e.g., through an OS or application/service); instant messages; group messages; and reminders, among other examples. In some examples, users may set specific types of contact modalities for specific user computing devices associated with a service. For instance, a first user computing device (e.g., a smart phone) may receive text message notifications and another user computing device (e.g., a tablet) may receive e-mail message notifications.

In the example shown in processing device view 390, a user computing device is associated with a phone number that a user registered with the virtual assistant service. A first notification 392 may be received (and displayed on a display of the computing device) after a user registers a phone number with the virtual assistant service. The first notification 392 is a text message (e.g., SMS message). Subsequent notifications from the virtual assistant service may be received directly on the user computing device (or peripheral devices connected with the user computing device). For example, a second notification 394 is provided (e.g., a day later), where the second notification 394 is a reminder for an upcoming scheduled meeting. The second notification 394 provides details indicating that the virtual assistant service initiates a call communication for direct connection to the scheduled meeting. The second notification 394 is also provided as a text message (e.g., SMS message), corresponding with one or more registered modalities of the user through an interface of the virtual assistant service. Processing device view 390 further comprises receipt of an exemplary call communication 396 at the time of the scheduled meeting, where acceptance of the call communication connects the user computing device with an exemplary conferencing session. In alternative examples, a user may correspond with the virtual assistant service to set a specific time, action (e.g., another meeting attendee joins the conferencing session) for initiation of the call communication 396.

FIG. 4 illustrates a computing system 401 that is suitable for implementing processing of an exemplary virtual assistant as well as other applications/services of a platform (application platform). Computing system 401, which is representative of any system or collection of systems in which the various applications, services, scenarios, and processes disclosed herein may be implemented. Examples of computing system 401 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 401 may be implemented as a single apparatus, system, or device or may be implemented in a distributed manner as multiple apparatuses, systems, or devices. For example, computing system 401 may comprise one or more computing devices that execute processing for applications and/or services. Computing system 401 may comprise a collection of devices executing processing for front-end applications/services, back-end applications/service or a combination thereof. Computing system 401 includes, but is not limited to, processing system 402, storage system 403, software 405, communication interface system 407, and user interface system 409. Processing system 402 is operatively coupled with storage system 403, communication interface system 407, and user interface system 409.

Processing system 402 loads and executes software 405 from storage system 403. Software 405 includes applications/service such as virtual assistant service 406a, and other applications/services 406b that associated with an application platform, which may include a language understanding service, a custom search service, a service providing a bot framework and productivity applications/services, among other examples. Software 405 is representative of the processes discussed with respect to the preceding FIGS. 1-2, including operations related to spoken utterance processing (that implements components of process flow 100 (FIG. 1) and method 200 (FIG. 2). When executed by processing system 402, software 405 directs processing system 402 to operate as described herein for at least the various processes, operational scenarios, and sequences discussed in the foregoing implementations. Computing system 401 may optionally include additional devices, features, or functionality not discussed for purposes of brevity.

Referring still to FIG. 4, processing system 402 may comprise processor, a micro-processor and other circuitry that retrieves and executes software 405 from storage system 403. Processing system 402 may be implemented within a single processing device but may also be distributed across multiple processing devices or sub-systems that cooperate in executing program instructions. Examples of processing system 402 include general purpose central processing units, graphical processing units, application specific processors, and logic devices, as well as any other type of processing device, combinations, or variations thereof.

Storage system 403 may comprise any computer readable storage media readable by processing system 402 and capable of storing software 405. Storage system 403 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or other suitable storage media, except for propagated signals. In no case is the computer readable storage media a propagated signal.

In addition to computer readable storage media, in some implementations storage system 403 may also include computer readable communication media over which at least some of software 405 may be communicated internally or externally. Storage system 403 may be implemented as a single storage device but may also be implemented across multiple storage devices or sub-systems co-located or distributed relative to each other. Storage system 403 may comprise additional elements, such as a controller, capable of communicating with processing system 402 or possibly other systems.

Software 405 may be implemented in program instructions and among other functions may, when executed by processing system 402, direct processing system 402 to operate as described with respect to the various operational scenarios, sequences, and processes illustrated herein. For example, software 405 may include program instructions for implementing an exemplary virtual assistant application/service 406 and/or other applications/service of an application platform, as described in the foregoing description.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 405 may include additional processes, programs, or components, such as operating system software, virtual machine software, or other application software. Software 405 may also comprise firmware or some other form of machine-readable processing instructions executable by processing system 402.

In general, software 405 may, when loaded into processing system 402 and executed, transform a suitable apparatus, system, or device (of which computing system 401 is representative) overall from a general-purpose computing system into a special-purpose computing system customized to process note items and respond to queries. Indeed, encoding software 405 on storage system 403 may transform the physical structure of storage system 403. The specific transformation of the physical structure may depend on various factors in different implementations of this description. Examples of such factors may include, but are not limited to, the technology used to implement the storage media of storage system 403 and whether the computer-storage media are characterized as primary or secondary storage, as well as other factors.

For example, if the computer readable storage media are implemented as semiconductor-based memory, software 405 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 407 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 409 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 409. In some cases, the input and output devices may be combined in a single device, such as a display capable of displaying images and receiving touch gestures. The aforementioned user input and output devices are well known in the art and need not be discussed at length here.

User interface system 409 may also include associated user interface software executable by processing system 402 in support of the various user input and output devices discussed above. Separately or in conjunction with each other and other hardware and software elements, the user interface software and user interface devices may support a graphical user interface, a natural user interface, or any other type of user interface.

Communication between computing system 401 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method comprising:
extracting, from the electronic meeting invite, electronic conferencing details for a scheduled meeting;
detecting an occurrence of the scheduled meeting based on an analysis of the extracted conferencing details;
programmatically issuing, based on the detected occurrence, a communication, to a user computing device through a virtual assistant service, wherein the communication comprises a call communication for connecting the user computing device to a conferencing session associate with the scheduled meeting; and
automatically connecting the user computing device to the conferencing session based on an acceptance of the communication.

2. The method of claim 1, wherein the call communication is a Voice over Internet Protocol (VoIP) call communication, and wherein the acceptance of the communication is answering the VoIP call communication.

3. The method of claim 1, wherein the communication, is issued through a user interface of the virtual assistant service, and wherein the communication further comprises chat dialogue directed to a meeting attendee of the electronic meeting invite.

4. The method of claim 1, further comprising: initiating, on behalf of the user computing device, the call communication based on the extracted conferencing details; and forwarding the call communication, to the user computing device, and wherein the communication, provided through the virtual assistant service, comprises the forwarded call communication.

5. The method of claim 4, wherein the extracting comprises detecting a telephone number and meeting-specific login data from the electronic meeting invite, and wherein the initiating of the call communication utilizes the telephone number and the meeting-specific login data to connect to the conferencing session.

6. The method of claim 4, wherein the extracting comprises detecting meeting-specific uniform resource identifier (URI) from the electronic meeting invite, and wherein the initiating of the call communication utilizes the URI to connect to the conferencing session.

7. The method of claim 1, further comprising: adding, based on the detected occurrence of the scheduled meeting, the virtual assistant service to the conferencing session using the extracted electronic conferencing details.

8. The method of claim 7, further comprising: detecting, via the virtual assistant service, meeting attendee presence status from the conferencing session; and providing, through the virtual assistant service, a notification of meeting attendee presence status to the user computing device.

9. The method of claim 7, further comprising: receiving, through the virtual assistant service, an instructional command for update of attendees of the conferencing session; and notifying, via the conferencing session, meeting attendees based on a processing of the instructional command.

10. A system comprising:
at least one processor; and
a memory, operatively connected with the at least one processor, storing computer-executable instructions that, when executed by the at least one processor, causes the at least one processor to execute a method that comprises:
extracting, from the electronic meeting invite, electronic conferencing details for a scheduled meeting;
detecting an occurrence of the scheduled meeting based on an analysis of the extracted conferencing details;
programmatically issuing, based on the detected occurrence, a communication, to a user computing device through a virtual assistant service, wherein the communication comprises a call communication for connecting the user computing device to a conferencing session associate with the scheduled meeting; and
automatically connecting the user computing device to the conferencing session based on an acceptance of the communication.

11. The system of claim 10, wherein the call communication is a Voice over Internet Protocol (VoIP) call communication, and wherein the acceptance of the communication is answering the VoIP call communication.

12. The system of claim 10, wherein the communication, is issued through a user interface of the virtual assistant service, and wherein the communication further comprises chat dialogue directed to a meeting attendee of the electronic meeting invite.

13. The system of claim 10, wherein the method, executed by the at least one processor further comprises: initiating, on behalf of the user computing device, the call communication based on the extracted conferencing details; and forwarding the call communication, to the user computing device, and wherein the communication, provided through the virtual assistant service, comprises the forwarded call communication.

14. The system of claim 13, wherein the extracting comprises detecting a telephone number and meeting-specific login data from the electronic meeting invite, and wherein the initiating of the call communication utilizes the telephone number and the meeting-specific login data to connect to the conferencing session.

15. The system of claim 13, wherein the extracting comprises detecting meeting-specific uniform resource identifier (URI) from the electronic meeting invite, and wherein the initiating of the call communication utilizes the URI to connect to the conferencing session.

16. The system of claim 10, wherein the method, executed by the at least one processor further comprises: adding, based on the detected occurrence of the scheduled meeting, the virtual assistant service to the conferencing session using the extracted electronic conferencing details.

17. The system of claim 16, wherein the method, executed by the at least one processor further comprises: detecting, via the virtual assistant service, meeting attendee presence status from the conferencing session; and providing, through the virtual assistant service, a notification of meeting attendee presence status to the user computing device.

18. The system of claim 16, wherein the method, executed by the at least one processor further comprises: receiving, through the virtual assistant service, an instructional command for update of attendees of the conferencing session; and notifying, via the conferencing session, meeting attendees based on a processing of the instructional command.

19. A computer-readable storage media storing computer-executable instructions that, when executed by at least one processor, causes the at least one processor to execute a method comprising:
extracting, from the electronic meeting invite, electronic conferencing details for a scheduled meeting;
detecting an occurrence of the scheduled meeting based on an analysis of the extracted conferencing details;
programmatically issuing, based on the detected occurrence, a communication, to a user computing device through a virtual assistant service, wherein the communication comprises a call communication connecting the user computing device to a conferencing session for the scheduled meeting; and
automatically connecting the user computing device to the conferencing session based on an acceptance of the communication.

20. The computer-readable storage media of claim 19, wherein the executed method further comprising: initiating, on behalf of the user computing device, the call communication based on the extracted conferencing details; and forwarding the call communication, to the user computing device, and wherein the communication, provided through the virtual assistant service, comprises the forwarded call communication.
